(19) United States
(12) Patent Application Publication
(10) Pub. No.: US 2011/0279661 A1
(43) Pub. Date: Nov. 17, 2011

(54) ATTENTION ATTRACTING DEVICE AND IMAGE CAPTURING APPARATUS PROVIDED WITH THE SAME

(76) Inventor: Wen-Ying Pan Ho, New Taipei City (TW)

(21) Appl. No.: 13/104,458

(22) Filed: May 10, 2011

(30) Foreign Application Priority Data
May 17, 2010 (TW) 099115678

(51) Int. Cl. H04N 7/18

(52) U.S. Cl. 348/61; 348/E07.085

(57) ABSTRACT

An image capturing apparatus includes an image capturing device operable to output an actuating signal, and an attention attracting device connected to the image capturing device. The attention attracting device includes an attention attracting unit electrically operable for attracting attention, a signal receiving component electrically connected to the image capturing device for receiving the actuating signal from the image capturing device, and a control circuit electrically connected to the attention attracting unit and the signal receiving component. The control circuit is operable, in response to receipt of the actuating signal from the signal receiving component, to control operation of the attention attracting unit for attracting attention.

### CROSS-REFERENCE TO RELATED APPLICATION

This application claims priority of Taiwanese Application No. 099115678, filed on May 17, 2010.

### BACKGROUND OF THE INVENTION

1. Field of the Invention

The present invention relates to an attention attracting device, more particularly to an attention attracting device configured to be installed on an image capturing apparatus.

2. Description of the Related Art

Generally, there is a problem that a target to be photographed does not look at a camera lens or does not follow directions from a photographer during photography. Particularly, when taking a picture of an infant or a child, the infant or the child may not look at the camera lens according to directions from the photographer. Thus, the photographer needs to attract the attention of the infant, for example, using a toy so that the photographer may be unable to concentrate on taking good pictures.

In another case, when taking a photo of a famous person in a public space, the target may only face one of multiple cameras or video cameras in the public space. Similarly, the photographer needs to attract the attention of the target, for example, by calling the target's name.

### SUMMARY OF THE INVENTION

Therefore, an object of the present invention is to provide an attention attracting device capable of attracting attention of a target during photography.

Accordingly, an attention attracting device of the present invention is configured to be connected to an image capturing device that is operable to output an actuating signal. The attention attracting device comprises an attention attracting unit electrically operable for attracting attention, a signal receiving component configured to be electrically connected to the image capturing device for receiving the actuating signal therefrom, and a control circuit electrically connected to the attention attracting unit and the signal receiving component. The control circuit is operable, in response to receipt of the actuating signal from the signal receiving component, to control operation of the attention attracting unit for attracting attention.

According to another aspect, an image capturing apparatus of the present invention comprises an image capturing device operable to output an actuating signal, and an attention attracting device connected to the image capturing device. The attention attracting device includes an attention attracting unit electrically operable for attracting attention, a signal receiving component electrically connected to the image capturing device for receiving the actuating signal therefrom, and a control circuit electrically connected to the attention attracting unit and the signal receiving component. The control circuit is operable, in response to receipt of the actuating signal from the signal receiving component, to control operation of the attention attracting unit for attracting attention.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a first preferred embodiment of an image capturing apparatus provided with an attention attracting device according to this invention;

FIG. 2 is a perspective view of a base of the attention attracting device of the first preferred embodiment;

FIG. 3 is a block diagram of the attention attracting device of the first preferred embodiment;

FIG. 4 is a perspective view of the image capturing apparatus of the first preferred embodiment;

FIG. 5 is an exploded perspective view of a second preferred embodiment of the image capturing apparatus provided with an attention attracting device according to this invention;

FIG. 6 is a perspective view of an extender rod of the attention attracting device of the second preferred embodiment;

FIG. 7 is a block diagram of the attention attracting device of the second preferred embodiment;

FIG. 8 is a perspective view of the image capturing apparatus of the second preferred embodiment;

FIG. 9 is an exploded perspective view of a third preferred embodiment of the image capturing apparatus provided with an attention attracting device according to this invention;

FIG. 10 is a perspective view of the image capturing apparatus of the third preferred embodiment;

FIG. 11 is an exploded perspective view of a fourth preferred embodiment of the image capturing apparatus provided with an attention attracting device according to this invention;

FIG. 12 is a perspective view of the image capturing apparatus of the fourth preferred embodiment; and

FIG. 13 is a perspective view of a fifth preferred embodiment of the image capturing apparatus provided with an attention attracting device according to this invention.

### DETAILED DESCRIPTION OF THE PREFERRED EMBODIMENTS

Before the present invention is described in greater detail, it should be noted that like elements are denoted by the same reference numerals throughout the disclosure.

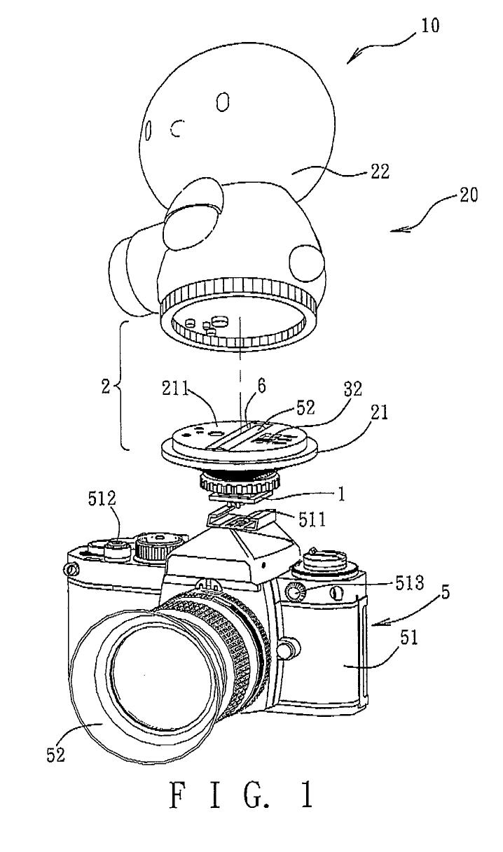

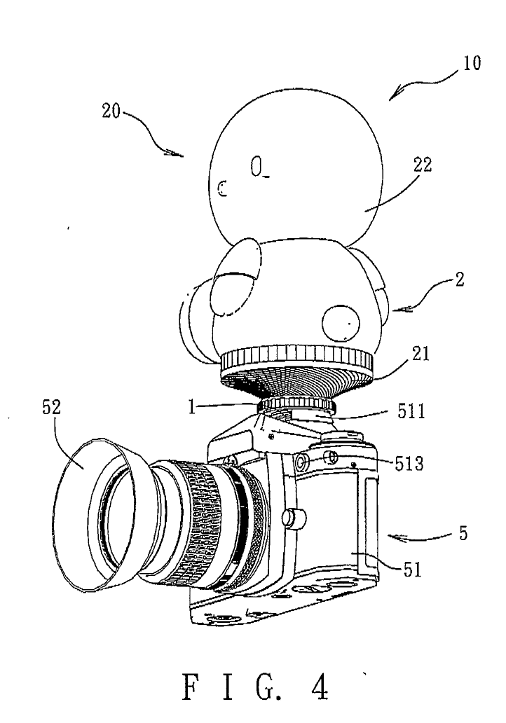

Referring to FIGS. 1 to 4, a first preferred embodiment of an image capturing apparatus 10 of the present invention includes an image capturing device 5, and an attention attracting device 20 configured to be connected to the image capturing device 5.

The image capturing device 5 may be, for example, a camera, a video camera, or other image/video capturing equipment, and is illustrated as a camera in this embodiment. The image capturing device 5 is operable to output an actuating signal, and includes a camera lens 52, a camera body 51, and a hot-shoe contact 511, a shutter release button 512 and a remote control terminal 513 that are disposed at the camera body 51. In this embodiment, the image capturing device 5 is operable to output a hot-shoe signal via the hot-shoe contact 511 when the shutter release button 512 is pressed, and the hot-shoe signal serves as the actuating signal.

The attention attracting device 20 includes a signal receiving component 1, an attention attracting unit 2, and a control circuit 3.

The attention attracting unit 2 is electrically operable for attracting attention of a target during photography, and includes a disc-like base 21 and an electrically operable attracting component 22 mounted on the base 21. The base 21 has a top surface 211 formed with a battery seat 6 for receiving a battery 52 that is used for provision of electric power to the attracting component 22 and the control circuit 3.

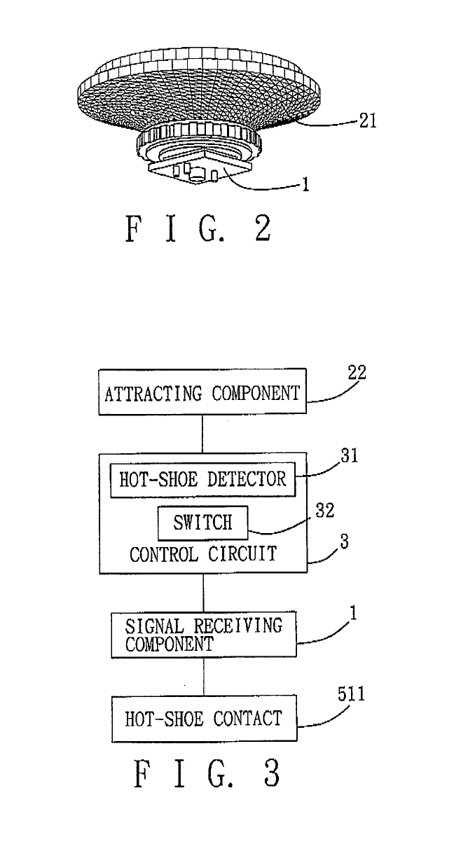

The signal receiving component 1 is configured to be electrically connected to the hot-shoe contact 511 for receiving the actuating signal therefrom. The configuration of the hot-shoe contact 511 may vary depending on the manufacturer of the image capturing device 5. In other words, the signal receiving component may have different configurations for matching with different hot-shoe contacts. In this embodiment, the signal receiving component 1 is connected to a bottom side of the base 21 as shown in FIG. 2.

The control circuit 3 is a circuit board (not show) disposed in the base 21, and is configured for receiving the electric power from the battery 6 in the battery seat 52 of the base 21. As shown in FIG. 3, the control circuit 3 is electrically connected to the attracting component 22 and the signal receiving component 1. The control circuit 3 is operable, in response to receipt of the actuating signal from the signal receiving component 1, to control operation of the attracting component 22 of the attention attracting unit 2 for attracting attention. In particular, the control circuit 3 is operable to amplify the actuating signal, and to send the amplified signal to the attracting component 22 for actuating the attracting component 22.

In this embodiment, the control circuit 3 includes a hot-shoe detector 31 capable of detecting the actuating signal (i.e., the hot-shoe signal from the hot-shoe contact 511). Upon detecting the actuating signal, the hot-shoe detector 31 is operable to amplify the actuating signal, and to send the amplified signal to the attracting component 22 for actuating the attracting component 22.

During photography, a photographer may slightly press the shutter release button 512 so as to actuate the image capturing device 5 to detect the environment and to obtain feedback values, such as a diameter of an aperture, a shutter speed, an exposure value, a focus mode, a state of a flash, etc. When the photographer slightly presses the shutter release button 512, the image capturing device 5 is also operable to generate and provide the hot-shoe signal to the hot-shoe contact 511 for detecting presence of a flash connected to the hot-shoe contact 511 and for determining an amount of output to the flash if there is a flash. The hot-shoe signal serves as the actuating signal in this embodiment, and is transmitted to the control circuit 3 through the hot-shoe contact 511 and the signal receiving component 1. Upon detecting the hot-shoe signal, the hot-shoe detector 31 of the control circuit 3 is operable to amplify the hot-shoe signal, and to send the amplified signal to the attracting component 22 of the attention attracting unit 2 for actuating the attracting component 22.

In practice, the attracting component 22 may include a lighting module having a light-emitting diode, and an audio module having a speaker. The amplified signal from the control circuit 3 actuates the lighting module and the audio module to make the light-emitting diode and the speaker generate a visible flashing light output and an audio output, respectively, to thereby attract the attention of the target so that the target may look at the camera lens 52 of the image capturing device 5. It should be noted that an appearance and a shape of the attracting component 22 may be designed for different targets, and are not limited to the disclosure in this embodiment. Further, aside from the lighting module and the audio module, the attracting component 22 may include other modules configured to generate different attention attracting effects, such as vibratory movement, shape transformation, swaying movement, and other movement capable of attracting attention.

Preferably, the control circuit 3 further includes a switch 32 disposed on the top surface 211 of the base 21. In this embodiment, the switch 32 is a three-state switch switchable among a turn-off state, a turn-on state and a forced actuation state. The control circuit 3 will not operate to actuate the attracting component 22 when the switch 32 is in the turn-off state, and will operate to actuate the attracting component 22 in response to receipt of the actuating signal when the switch 32 is in the turn-on state. In the forced actuation state, the control circuit 3 is operable to S continuously generate a forced signal to actuate the attracting component 22 without receiving the actuating signal. In other embodiments, the switch 32 may be a two-state switch movable between the turn-off state and the turn-on state.

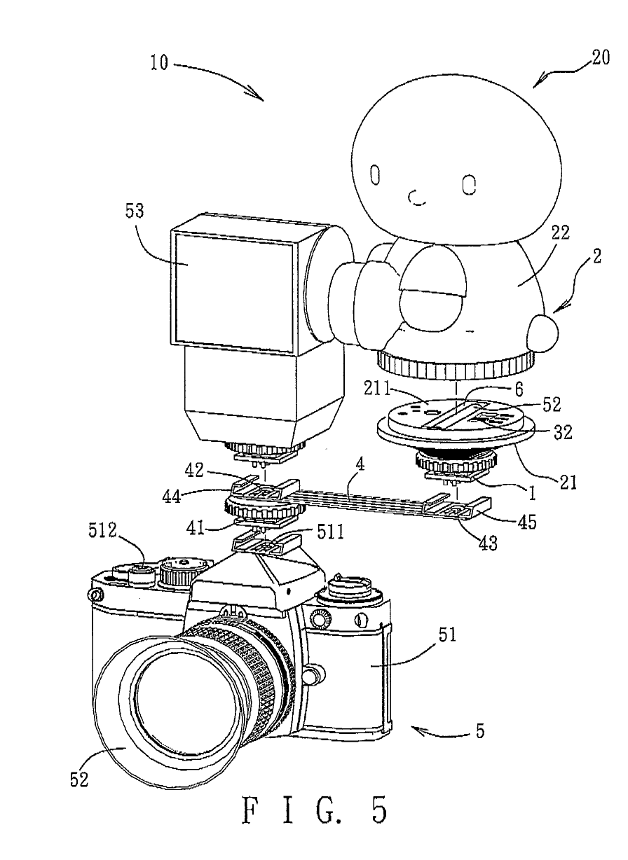

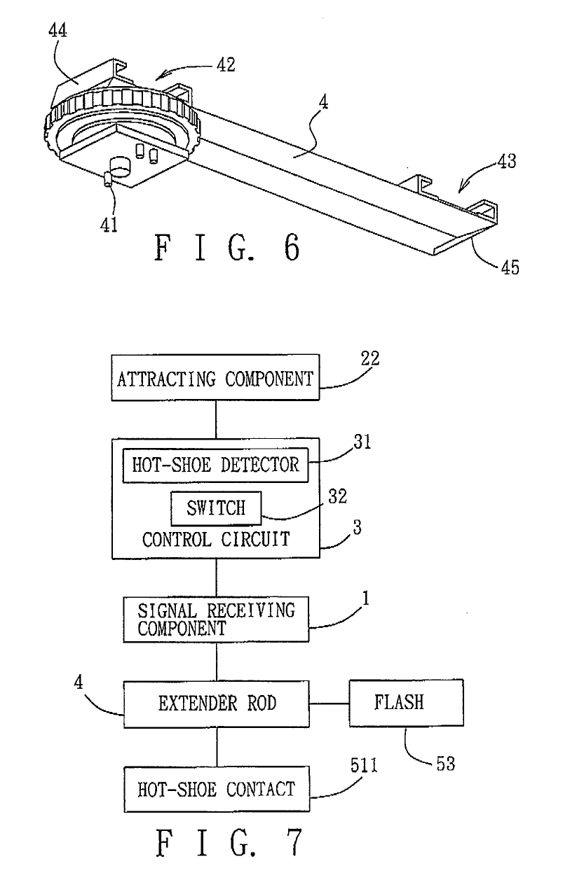

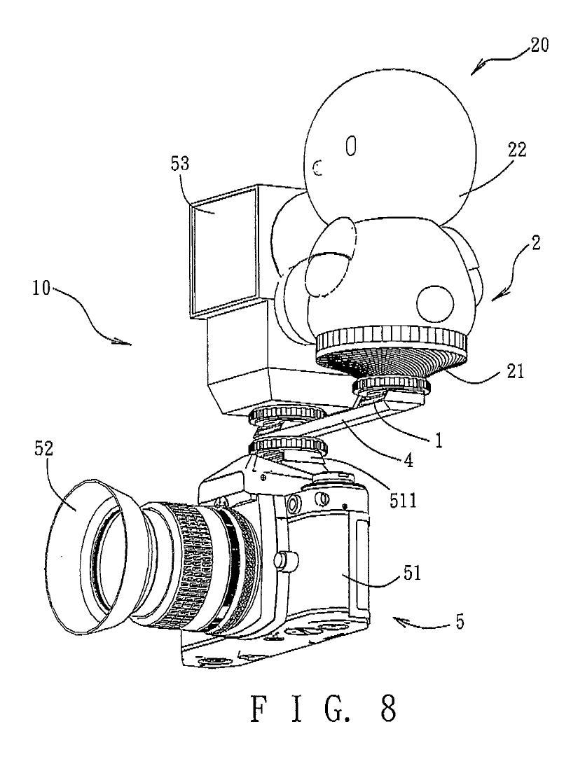

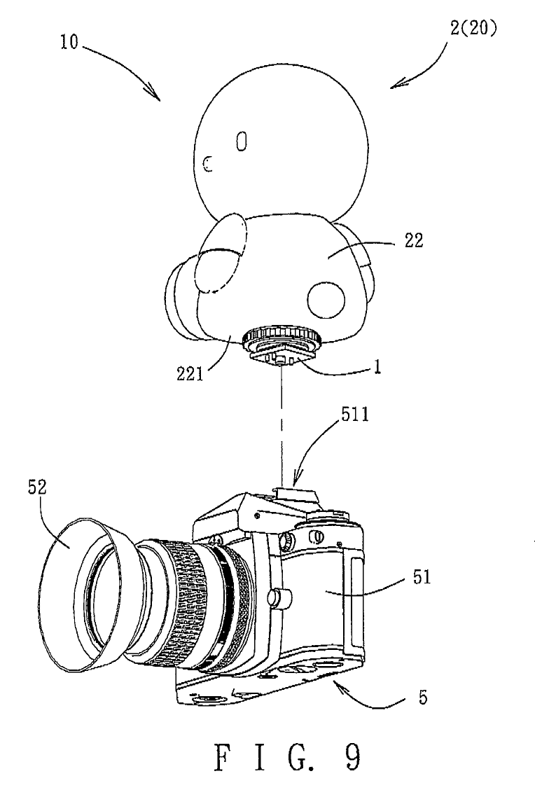

Referring to FIGS. 5 to 8, a second preferred embodiment of an image capturing apparatus 10 of the present invention is similar to the first preferred embodiment. In this embodiment, the image capturing device 5 further includes a flash 53, and the attention attracting device 20 further includes an extender rod 4 having a first end 44 and a second end 45. The extender rod 4 includes a signal feed-in part 41 disposed at a bottom side of the first end 44, and a pair of signal output parts 42, 43 disposed on top sides of the first and second ends 44 and 45, respectively. The signal feed-in part 41 is connected to the hot-shoe contact 511 for receiving the actuating signal therefrom, and transmits the actuating signal to the signal output parts 42, 43. The signal output parts 42, 43 are connected to the flash 53 and the signal receiving component 1 for providing the actuating signal thereto, respectively.

When the photographer slightly presses the shutter release button 512 of the image capturing device 5, the image capturing device 5 is operable to generate the actuating signal (i.e., the hot-shoe signal) and to provide the actuating signal to the hot-shoe contact 511. The actuating signal is transmitted to the flash 53 and the signal receiving component 1 through the extender rod 4. The flash 53 is operable to meter environmental light in response to receipt of the actuating signal via the signal output part 42, and to generate a flashing light output when the photographer certainly presses the shutter release button 512. Upon detecting the actuating signal, the hot-shoe detector 31 of the control circuit 3 is operable to actuate the attracting component 22 of the attention attracting unit 2 to generate the attention attracting effects, i.e., the visible flashing light output and the audio output, to thereby attract the attention of the target. Thus, the target may look at the camera lens 52 of the image capturing device 5 when the photographer certainly presses the shutter release button 512.

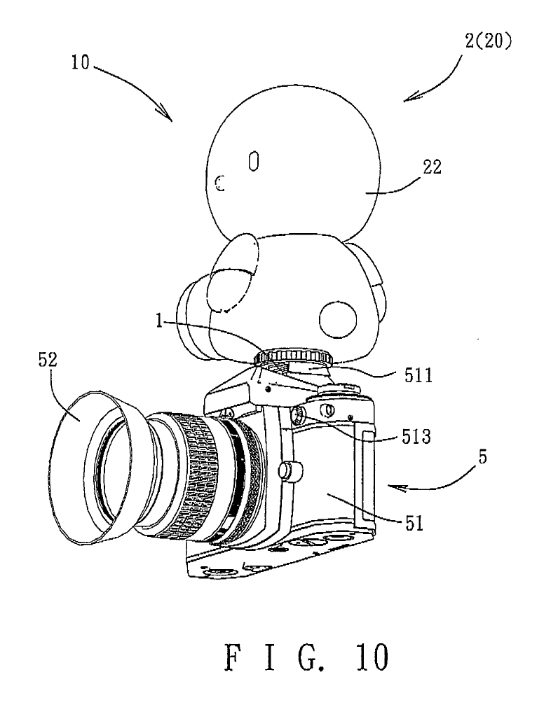

Referring to FIGS. 9 and 10, a third preferred embodiment of an image capturing apparatus 10 of the present invention is similar to the first preferred embodiment. In this embodiment, the attention attracting unit 2 merely includes the electrically operable attracting component 22 without a base. The signal receiving component 1 is directly connected to a bottom part 221 of the attracting component 22, and the control circuit (not shown) is disposed in the attracting component 22. The control circuit only includes the hot-shoe detector actuating the attracting component 22 in response to detection of the actuating signal. Further, a rechargeable battery (not shown) connected to a circuit board of the control circuit is used for providing electric power to the attracting component 22 and the control circuit instead of the battery 52 of the first preferred embodiment.

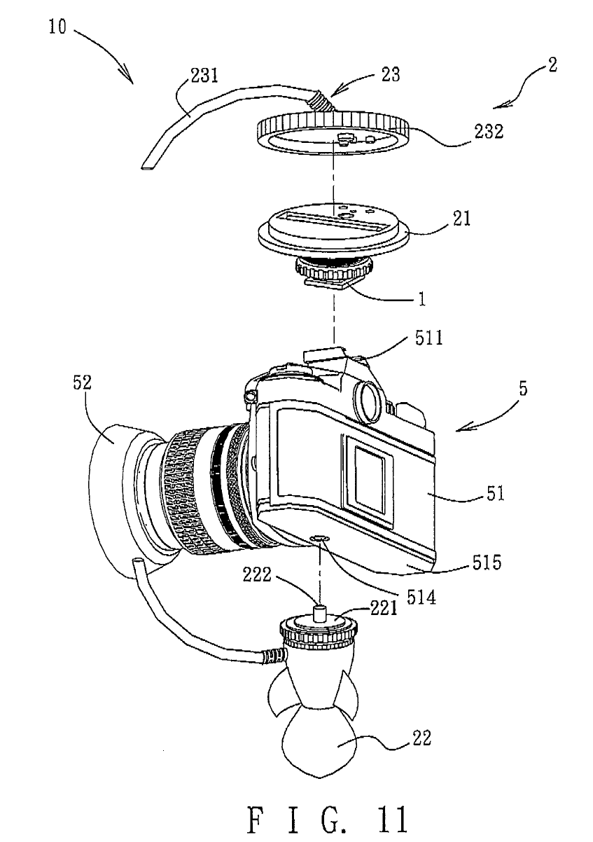

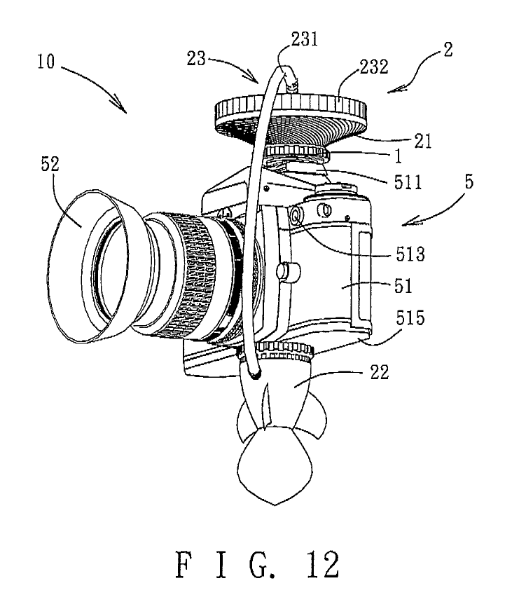

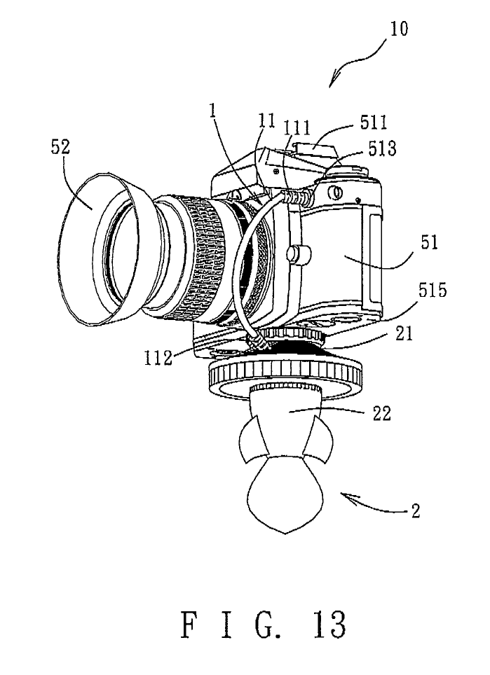

FIGS. 11 and 12 illustrate a fourth preferred embodiment of an image capturing apparatus 10 of the present invention. In this embodiment, the attention attracting unit 2 further includes a transmission component 23 consisting of a cap 231 and a transmission cable 231. The cap 232 is mounted on the base 21 and is electrically connected to the control circuit (not shown). The transmission cable 232 has one end connected to the cap 232, and the other end connected to the attracting component 22. The control circuit only includes the hot-shoe detector actuating the attracting component 22 in response to detection of the actuating signal. Further, a rechargeable battery (not shown) connected to a circuit board of the control circuit is used for providing electric power to the attracting component 22 and the control circuit instead of the battery 52 of the first preferred embodiment.

In this embodiment, the camera body 51 of the image capturing device 5 has a bottom 515 formed with a hole 514 generally used for mounting of the image capturing device 5 on a tripod. The attracting component 22 is separated from the base 21, and includes a bottom part 221 provided with a fastener 222 that is configured to be engage removably the hole 514. Thus, the attracting component 22 can be directly and removably connected to the bottom 515 of the image capturing device 5 via the engagement between the fastener 222 and the hole 514.

FIG. 13 illustrates a fifth preferred embodiment of an image capturing apparatus 10 of the present invention. In this embodiment, the image capturing device 5 is operable to output the actuating signal (i.e., the hot-shoe signal) through the remote control terminal 513. The signal receiving component 1 includes a conductor 11. The conductor 11 has a first end 111 electrically connected to the remote control terminal 513 for receiving the actuating signal, and a second end 112 connected to the base 21, which is connected to the bottom 515 of the camera body 51 of the image capturing device 5, for electrical connection with the control circuit (not shown) in the base 21. Further, the base 21 of the attention attracting unit 2 can be omitted in this embodiment. Accordingly, the control circuit may be disposed in the attracting component 22, and the second end 112 of the conductor 11 is connected to the attracting component 22 for electrical connection with the control circuit. It should be noted that the positions of the base 21 and the attracting component 22 of the attention attracting unit 2 are not limited to the disclosure in the foregoing embodiments. In other embodiments, the base 21 or the attracting component 22 may be disposed on the camera lens 52 or other suitable parts of the image capturing device 5.

In summary, in response to receipt of the actuating signal (i.e., the hot-shoe signal) from the signal receiving component 1, the control circuit 3 is operable to amplify the actuating signal and to send the amplified signal to the attention attracting unit 2 for actuating the attention attracting unit 2. The attention attracting unit 2 is actuated to generate the attention attracting effect including the visible flashing light output, the audio output, the vibratory movement, the shape transformation, and/or the swaying movement. Thus, the target's attention can be attracted by the attention attracting effect so that the target may look at the camera lens 52, and the photographer may be able to concentrate on taking pictures of the target.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An image capturing apparatus, comprising:
an image capturing device operable to output an actuating signal;
an attention attracting unit electrically operable for attracting attention;
a signal receiving component electrically connected to said image capturing device for receiving the actuating signal from said image capturing device; and
a control circuit electrically connected to said attention attracting unit and said signal receiving component, said control circuit being operable, in response to receipt of the actuating signal from said signal receiving component, to control operation of said attention attracting unit for attracting attention.

2. The image capturing apparatus as claimed in claim 1, wherein said image capturing device includes a hot-shoe contact and is operable to output a hot-shoe signal via said hot-shoe contact, the hot-shoe signal serving as the actuating signal, said signal receiving component being connected to said hot-shoe contact, said control circuit including a hot-shoe detector capable of actuating said attention attracting unit in response to detection of the actuating signal.

3. The image capturing apparatus as claimed in claim 1, wherein said attention attracting unit includes:
a base at which said control circuit is disposed; and
an electrically operable attracting component mounted on said base, electrically connected to said control circuit, and controlled by said control circuit to operate for attracting attention;
said signal receiving component being connected to said base for electrical connection with said control circuit.

4. The image capturing apparatus as claimed in claim 1, wherein;
said image capturing device includes a flash and a hot-shoe contact, and is operable to output a hot-shoe signal via said hot-shoe contact, the hot-shoe signal serving as the actuating signal;
said signal receiving component and said control circuit are disposed at said attention attracting unit;
said attention attracting unit includes an electrically operable attracting component electrically connected to said control circuit;
said image capturing apparatus further comprises an extender rod including a signal feed-in part and a pair of signal output parts;
said signal feed-in part is connected to said hot-shoe contact for receiving the actuating signal therefrom and transmits the actuating signal to said signal output parts;
one of said signal output parts is connected to said signal receiving component for providing the actuating signal thereto;
the other one of said signal output parts is connected to said flash for providing the actuating signal thereto; and
said control circuit includes a hot-shoe detector capable of actuating said attracting component in response to detection of the actuating signal.

5. The image capturing apparatus as claimed in claim 4, wherein said attention attracting unit further includes a base, said control circuit being disposed at said base, said attracting component being mounted on said base, said signal receiving component being connected to said base for electrical connection with said control circuit.

6. The image capturing apparatus as claimed in claim 1, wherein said attention attracting unit includes:
a base having said control circuit mounted thereon;
a transmission component having one end connected to said base; and
an electrically operable attracting component connected to another end of said transmission component and electrically connected to said control circuit via said transmission component, said attracting component being controlled by said control circuit to operate for attracting attention.

7. The image capturing apparatus as claimed in claim 6, wherein said image capturing device includes a bottom, said attracting component of said attention attracting unit being directly and removably connected to said bottom of said image capturing device.

8. The image capturing apparatus as claimed in claim 1, wherein said image capturing device includes a remote control terminal and is operable to output a hot-shoe signal through said remote control terminal, the hot-shoe signal serving as the actuating signal, said signal receiving component including a conductor electrically connected to said remote control terminal for receiving the actuating signal, said control circuit including a hot-shoe detector capable of actuating said attention attracting unit in response to detection of the actuating signal.

9. The image capturing apparatus as claimed in claim 8, wherein said attention attracting unit includes a base having said control circuit mounted thereon, and an electrically operable attracting component mounted on said base, electrically connected to said control circuit, and controlled by said control circuit to operate for attracting attention,
said conductor of said signal receiving component having one end connected to said base for electrical connection with said control circuit, and another end electrically connected to said remote control terminal.

10. The image capturing apparatus as claimed in claim 1, wherein said attention attracting unit is controlled by said control circuit to generate at least one attention attracting effect selected from an audio output, a visible flashing light output, vibratory movement, shape transformation, and swaying movement.

11. An attention attracting device configured to be connected to an image capturing device that is operable to output an actuating signal, said attention attracting device comprising:
an attention attracting unit electrically operable for attracting attention;
a signal receiving component configured to be electrically connected to the image capturing device for receiving the actuating signal from the image capturing device; and
a control circuit electrically connected to said attention attracting unit and said signal receiving component, said control circuit being operable, in response to receipt of the actuating signal from said signal receiving component, to control operation of said attention attracting unit for attracting attention.

12. The attention attracting device as claimed in claim 11, the image capturing device including a hot-shoe contact and being operable to output a hot-shoe signal via said hot-shoe contact, the hot-shoe signal serving as the actuating signal,
wherein said signal receiving component is configured to be connected to the hot-shoe contact, and said control circuit includes a hot-shoe detector capable of actuating said attention attracting unit in response to detection of the actuating signal.

13. The attention attracting device as claimed in claim 11, wherein said attention attracting unit includes:
a base at which said control circuit is disposed; and
an electrically operable attracting component mounted on said base, electrically connected to said control circuit, and controlled by said control circuit to operate for attracting attention;
said signal receiving component being connected to said base for electrical connection with said control circuit.

14. The attention attracting device as claimed in claim 11, the image capturing device including a flash and a hot-shoe contact, and being operable to output a hot-shoe signal via the hot-shoe contact, the hot-shoe signal serving as the actuating signal, wherein:
said signal receiving component and said control circuit are disposed at said attention attracting unit;
said attention attracting unit includes an electrically operable attracting component electrically connected to said control circuit;
said attention attracting device further comprises an extender rod including a signal feed-in part and a pair of signal output parts;
said signal feed-in part is configured to be connected to the hot-shoe contact for receiving the actuating signal therefrom and transmits the actuating signal to said signal output parts;
one of said signal output parts is connected to said signal receiving component for providing the actuating signal thereto;
the other one of said signal output parts is connected to said flash for providing the actuating signal thereto; and
said control circuit includes a hot-shoe detector capable of actuating said attracting component in response to detection of the actuating signal.

15. The attention attracting device as claimed in claim 14, wherein said attention attracting unit further includes a base, said control circuit being disposed at said base, said attracting component being mounted on said base, said signal receiving component being connected to said base for electrical connection with said control circuit.

16. The attention attracting device as claimed in claim 11, wherein said attention attracting unit includes:
a base having said control circuit mounted thereon;
a transmission component having one end connected to said base; and
an electrically operable attracting component connected to another end of said transmission component and electrically connected to said control circuit via said transmission component, said attracting component being controlled by said control circuit to operate for attracting attention.

17. The attention attracting device as claimed in claim 16, the image capturing device including a bottom,
wherein said attracting component of said attention attracting unit is configured to be directly and removably connected to the bottom of the image capturing device.

18. The attention attracting device as claimed in claim 11, the image capturing device including a remote control terminal and being operable to output a hot-shoe signal through the remote control terminal, the hot-shoe signal serving as the actuating signal,
wherein said signal receiving component includes a conductor configured to be electrically connected to the remote control terminal for receiving the actuating signal, and said control circuit includes a hot-shoe detector capable of actuating said attention attracting unit in response to detection of the actuating signal.

19. The attention attracting device as claimed in Claim 18, wherein said attention attracting unit includes a base having said control circuit mounted thereon, and an electrically operable attracting component mounted on said base, electrically connected to said control circuit, and controlled by said control circuit to operate for attracting attention,
said conductor of said signal receiving component having one end connected to said base for electrical connection with said control circuit, and another end configured to be electrically connected to the remote control terminal.

20. The attention attracting device as claimed in claim 11, wherein said attention attracting unit is controlled by said control circuit to generate at least one attention attracting effect selected from an audio output, a visible flashing light output, vibratory movement, shape transformation, and swaying movement.
